(19) United States
(12) Patent Application Publication
(10) Pub. No.: US 2026/0365105 A1
(43) Pub. Date: Nov. 19, 2026

(54) LED MODULE AND A LAMP INCLUDING THE SAME

(71) Applicants: HYUNDAI MOTOR COMPANY, Seoul (KR); KIA CORPORATION, Seoul (KR); HATBIT ILLUCOM CO., LTD, Bucheon-si (KR); DY DEOKYANG CO.,LTD, Ulsan (KR)

(72) Inventors: Yeong Jae Jang, Hwaseong-si (KR); Ji Yun Ha, Hwaseong-si (KR); Sang Woo Park, Seoul (KR); Young Ho Cha, Incheon (KR); Joong Sam Park, Ansan-si (KR); Su Young Kim, Cheonan-si (KR); Sueng Ho Kim, Ulsan (KR)

(73) Assignees: HYUNDAI MOTOR COMPANY, Seoul (KR); KIA CORPORATION, Seoul (KR); HATBIT ILLUCOM CO., LTD, Bucheon-si (KR); DY DEOKYANG CO.,LTD, Ulsan (KR)

(21) Appl. No.: 19/412,287

(22) Filed: Dec. 8, 2025

(30) Foreign Application Priority Data
May 19, 2025 (KR) 10-2025-0064911

(51) Int. Cl. B60Q 3/66; B60Q 3/62; B60Q 3/64; F21V 8/00

(52) U.S. Cl. CPC B60Q 3/66; G02B 6/0016; G02B 6/0036; G02B 6/0043; G02B 6/0076; B60Q 3/62; B60Q 3/64

(57) ABSTRACT

An LED module includes an LED light source, a light guide disposed adjacent to the LED light source and constituted by a plurality of laminated layers, a first diffuser formed at the light guide and configured to diffuse light incident from the LED light source, and a second diffuser formed at the light guide and configured to re-diffuse light diffused through the first diffuser.

### CROSS-REFERENCE TO THE RELATED APPLICATION

This application claims priority to Korean Patent Application No. 10-2025-0064911, filed on May 19, 2025 in the Korean Intellectual Property Office, the disclosure of which is incorporated herein by reference in its entirety.

### FIELD

The present disclosure relates to an LED module configured to diffuse light emitted from an LED light source, thereby enhancing illumination uniformity, and a lamp including the LED module.

### BACKGROUND

Interior lighting in a vehicle is one of the important components for ensuring driver visibility and providing a comfortable interior environment. In particular, for an interior light using an LED light source, light uniformity should be secured to prevent blotching (e.g., unevenness or inconsistency) of the light source and to improve visibility.

Once light uniformity is secured, positive effects may be obtained in that it may be possible to reduce visual discomfort of passengers, to increase the overall quality of the lighting design, and to meet the affective quality required in luxury vehicles. In particular, during nighttime driving, brightness variations in interior lighting may affect the driver's concentration and fatigue, and uniform light output may prevent operational errors, inconveniences, etc. of the user.

Therefore, improving the uniformity of light output in vehicle interior lighting is recognized as an important element that goes beyond mere aesthetic enhancement, contributing to improved visibility for a driver and passengers, securing affective quality, and enhancing brand reliability.

The above matters disclosed in this section are provided merely to enhance understanding of the general background of the disclosure and should not be construed as an acknowledgement or any form of suggestion that the matters form the related art already known to a person skilled in the art.

### SUMMARY

The present disclosure provides an LED module configured to diffuse light emitted from an LED light source, thereby enhancing illumination uniformity, and a lamp which includes the LED module and utilizes light reflection to enable the user to perceive a plurality of images.

Aspects of the present disclosure are not limited to the above-described aspect, and other aspects of the present disclosure not yet described should be more clearly understood by those having ordinary skill in the art from the following detailed description.

In an embodiment of the present disclosure, an LED module includes: an LED light source, a light guide disposed adjacent to the LED light source and constituted by a plurality of laminated layers, a first diffuser formed at one surface of the light guide facing the LED light source and configured to diffuse light incident from the LED light source, and a second diffuser formed at a boundary surface among the plurality of layers of the light guide and configured to re-diffuse light that has been diffused through the first diffuser.

The first diffuser may be formed to have a bent shape such that the light incident on the first diffuser from the LED light source is refracted and diffused.

The first diffuser may have a protruding shape extending in a direction along which light emitted from the LED light source propagates.

A portion of an outer surface of the light guide, corresponding to the LED light source, may be recessed in a direction opposite to the LED light source, thereby forming the first diffuser.

The first diffuser may be formed at a position corresponding to the LED light source such that the first diffuser accommodates light emitted from the LED light source.

The second diffuser may have a width greater than a width of the first diffuser.

The second diffuser may have a bent shape configured to refract and diffuse light incident upon the second diffuser as the incident light passes through the second diffuser.

The second diffuser may include a plurality of bent portions disposed continuously.

The second diffuser may have a protruding shape extending in a direction along which light emitted from the LED light source propagates.

The distance between the second diffuser and an opposite surface of the light guide may be longer than the distance between the first diffuser and the second diffuser.

The second diffuser may be formed at a position corresponding to the first diffuser to accommodate light diffused by the first diffuser.

A portion of the boundary surface among the plurality of layers of the light guide may be bent, thereby forming the second diffuser.

The LED module may comprise a plurality of LED light source sets spaced apart from one another. Each of the plurality of LED light source sets may include the LED light source, the light guide, the first diffuser, and the second diffuser. An overlap region is defined between adjacent LED light source sets. The overlap region is configured such that light beams emitted by the adjacent LED light source sets overlap.

An independent region is defined in which light beam by each of the LED light source sets do not overlap with the light beams emitted from the adjacent LED light source sets, and the overlap regions and the independent regions may be alternately formed.

At least one of the plurality of laminated layers includes scattering particles dispersed therein. The scattering particles have a size corresponding to a wavelength of light emitted from the LED light source.

In another aspect of the present disclosure, a lamp includes: an LED module including an LED light source, a light guide including a plurality of laminated layers, a first diffuser formed at one surface of the light guide facing the LED light source, and a second diffuser formed at a boundary surface among the layers of the light guide, a high-reflectivity part disposed at a first side of the LED module and configured to reflect incident light emitted from the LED module, and a low-reflectivity part disposed at a second side of the LED module and configured to reflect a part of incident light emitted from the LED module and to transmit a remaining part of the incident light.

Among the light emitted from the LED module, light directed toward a user after directly passing through the low-reflectivity part may form an actual image of the LED light source.

Among the light emitted from the LED module, light directed toward a user after being reflected by the high-reflectivity part and then passing through the low-reflectivity part may form a virtual image on a virtual plane passing through the LED light source in a state of being spaced apart from the LED light source.

The virtual image may be recognized as several different virtual images in accordance with reflection paths of light emitted from the LED module by the high-reflectivity part or the low-reflectivity part. Reflections from at least one of the high-reflectivity part or the low-reflectivity part along different paths form multiple virtual images. a number of the virtual images may vary based on at least one of a height of the high-reflectivity part, a height of the low-reflectivity part, or a distance between the high-reflectivity part and the low-reflectivity part.

The low-reflectivity part may be formed such that transmittance thereof for incident light is higher than reflectance thereof for the incident light.

### BRIEF DESCRIPTION OF THE DRAWINGS

The above and other aspects, features and other advantages of the present disclosure should be more clearly understood from the following detailed description taken in conjunction with the accompanying drawings, in which:

FIG. 1 is a perspective view showing installation of a lamp according to an embodiment;

FIG. 2 is a cross-sectional view of the lamp taken along line A-A in FIG. 1;

FIG. 3 is an enlarged view of a portion B in FIG. 2;

FIG. 4 is a sectional view of an LED module according to an embodiment;

FIG. 5 is a view illustrating an independent region and an overlap region in the LED module according to an embodiment;

FIG. 6 is a view illustrating diffusion paths of light beams in the LED module according to an embodiment;

FIG. 7 is a view illustrating an actual image and virtual images of a lamp according to an embodiment; and

FIG. 8 is a view showing paths of light beams in a lamp according to another embodiment.

### DETAILED DESCRIPTION

In the following description of the embodiments of the present disclosure, a detailed description of known technologies incorporated herein has been omitted when it may obscure the subject matter of the embodiments of the present disclosure. In addition, the embodiments of the present disclosure should be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure. The following description is not intended to limit the present disclosure to the precise forms or particular fields of use disclosed. As such, it is contemplated that various alternate embodiments and/or modifications to the present disclosure, whether explicitly described or implied herein, are possible in light of the disclosure. A person of ordinary skill in the art should recognize that changes may be made in form and detail without departing from the scope of the present disclosure.

The present disclosure is described with reference to specific embodiments. However, as one skilled in the art would appreciate, various embodiments disclosed herein may be modified or otherwise implemented in various other ways without departing from the spirit and scope of the disclosure. Accordingly, the following description is to be considered as illustrative and is for the purpose of teaching those having ordinary skill in the art the manner of making and using various embodiments. It is to be understood that the forms of disclosure shown and described herein are to be taken as representative embodiments. Equivalent elements, materials, processes or steps may be substituted for those representatively illustrated and described herein. Expressions such as “including”, “comprising”, “incorporating”, “consisting of”, “have”, and “is” used to describe the present disclosure are intended to be construed in a non-exclusive manner, namely, in a manner allowing items, components or elements not explicitly described to be present. Unless clearly used otherwise, singular expressions should be interpreted as including a plural meaning.

Furthermore, various embodiments disclosed herein are to be taken in the illustrative and explanatory sense, and should in no way be construed as limitative of the present disclosure. All references as to joining (e.g., attached, affixed, coupled, connected, and the like) are only used to aid understanding of the present disclosure, and may not create limitations, particularly as to the position, orientation, or use of the configuration or the method disclosed herein. Therefore, references as to joining, if any, are to be construed broadly. Moreover, such references as to joining do not necessarily indicate that two elements are directly connected to each other. Additionally, all numerical terms, such as, but not limited to, “first”, “second”, “third”, “primary”, “secondary”, “main” or any other ordinal or numerical terms, should also be taken only as identifiers to assist understanding of various elements, embodiments, variations or modifications of the present disclosure, and may not mean any limitation as to embodiment, variation or modification of any element or any limitation as to the order or preference thereof. Although such expressions may be used to describe various constituent elements, these constituent elements are not limited by the expressions associated therewith. Such expressions are used only for distinguishment of one constituent element from another constituent element.

The suffixes “module” and “unit” of elements herein are used for convenience of description and thus may be used interchangeably and do not have any distinguishable meanings or functions.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

In addition, the term “unit” or “control unit” used in specific terminology is only a term widely used for designation of a controller for controlling a particular function of a vehicle and, as such, does not mean a generic functional unit.

The controller may include a communication device configured to communicate with another controller or a sensor for control of a function to be performed thereby, a memory configured to store an operating system, logic commands, input/output information, etc., and at least one processor configured to execute discrimination, calculation, determination, etc. required for control of the function to be performed. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

Any number of components or a variety of components of any one of the configurations disclosed in the present disclosure may be included in the present disclosure. Such components may include any combination of characterized parts disclosed in the present disclosure, and may be arranged to constitute any one of various configurations disclosed in the present disclosure. Not only structures and arrangements of the components of the present disclosure, but also concepts as to use and operation thereof, may be applied not only to particular embodiments discussed in the present disclosure, but also to embodiments of any numbers and in any combinations. In the following description, embodiments including various characterized parts having various arrangements will be described with reference to the accompanying drawings.

Hereinafter, various embodiments disclosed in the present disclosure are described in detail with reference to the accompanying drawings, and the same or similar elements are designated by the same reference numerals regardless of the numerals in the drawings and redundant description thereof will be omitted.

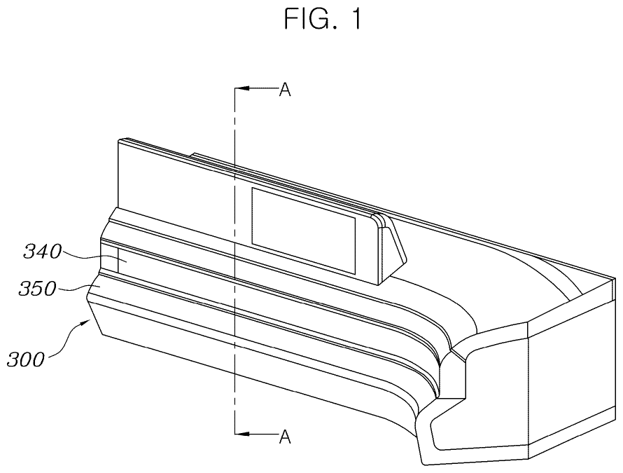

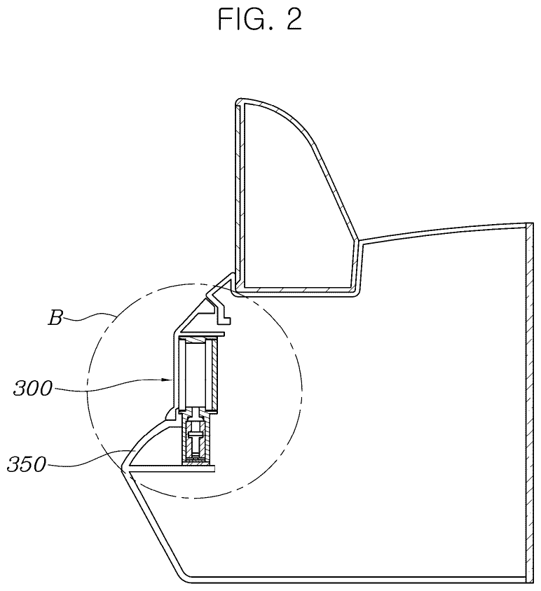

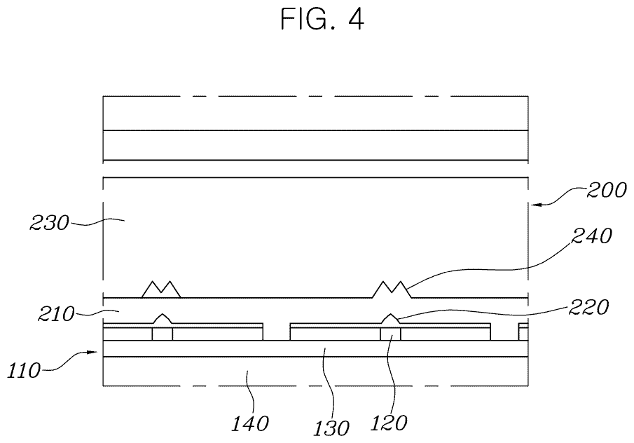

FIGS. 1 to 4 are views illustrating an LED module 100 according to an embodiment and a lamp 300 including the LED module 100. Referring to FIGS. 1 to 4 to explain the LED module 100 and the lamp 300, the LED module 100 includes an LED light source set 110 disposed at a substrate 130. The LED light source set 110 includes an LED light source 120, a first diffuser 220, a second diffuser 240, and a light guide 200.

The lamp 300 includes the LED module 100, a high-reflectivity part 310, a low-reflectivity part 320, an inner lens 330, and an outer lens 340. Although the LED module 100 according to an embodiment includes a plurality of LED light source sets 110, the LED module 100 is not limited thereto and may include a single LED light source set 110.

The lamp 300 may be disposed inside or outside a vehicle. For example, the outer lens 340 is exposed to enable the user 400 to recognize the outer lens 340, and the remaining parts of the lamp 300 are covered by a cover 350. Accordingly, light passing through the low-reflectivity part 320 exits and passes through the outer lens 340 to be perceived by the user 400.

The substrate cover 140 is a component used for structural protection, heat dissipation, waterproofing, dustproofing, electrical insulation, and aesthetic purposes. As a material of the substrate cover 140, PC, PMMA, PP, PBT, GF, silicon resin, a metal, etc. may be used. As a method of manufacturing the substrate cover 140, injection molding, compression, pressing, 3D printing, CNC machining, overmolding, or the like may be used. Particularly, for an LED module used in vehicle interior lighting, the substrate cover 140 should be manufactured taking into consideration heat resistance, electrical insulation, impact resistance, processability, design, and the like. When the substrate cover 140 is manufactured by injection molding using materials having excellent properties described above, such as PC or a combination of PC and GF, the performance described above may be enhanced.

The substrate 130 is a component for which properties such as thermal conductivity, electrical insulation, and durability are important. Therefore, materials such as glass fiber, epoxy resin, aluminum, ceramic, etc. may be used to form the substrate 130. Additionally, the substrate 130 may be manufactured through lamination, printing, or other methods. In particular, by using aluminum or ceramic, it may be possible to manufacture a substrate excellent in terms of thermal conductivity, cost-effectiveness, efficiency, and stiffness.

In an embodiment, light emitted from the LED light source 120 has directivity. However, the present disclosure is not limited to the above-described embodiment. The LED light source 120 may emit light diffusing over the entire range, partially diffusing in certain directions, or advancing in a straight line. In other words, the LED light source 120 may emit light uniformly diffused, directionally diffused, or collimated in a straight line.

The light guide 200 configured to diffuse the light emitted from the LED light source 120 includes a plurality of laminated layers. In an embodiment, the light guide 200 has a double-layer configuration including a first layer 210 and a second layer 230, but is not limited thereto. The light guide 200 may be configured by laminating a plurality of layers, for example, three or more layers, in accordance with its structural or performance requirements.

The light guide 200 includes a plurality of layers. For example, each layer may be formed of a material such as PMMA, PC, PS, PET, SAN, or the like. These layers may be manufactured by a method such as pattern printing, laser processing, mold injection, particle mixed extrusion, or the like. In particular, the PMMA material has advantages in that if offers high optical transmittance, the ability to uniformly mix particles, thermal stability within an LED's operating temperature range, a long lifespan, and ease of processing.

The first diffuser 220, which diffuses the light emitted from the LED light source 120, is formed at one surface of the first layer 210 facing the LED light source 120. When the LED light source 120 and the first diffuser 220 are disposed closely in the above-described manner, the light emitted from the LED source 120 enters the first diffuser 220 at wider variety of angles, leading to increased scattering and reflection. This results in wider diffusion of the light, thereby enhancing uniformity of the light.

The first diffuser 220 may have a bent shape. Light emitted from the LED light source 120 enters in a non-flat, bent form. As a result, light reflected on one surface of the first diffuser 220 is again incident upon another surface and is then reflected from the other surface and, as such, the advance direction of the light may be changed several times. Additionally, since light is incident upon the first diffuser 220 at various angles and is then refracted accordingly, the incident light is diffused in various directions by virtue of such reflection and refraction in various directions.

Since the first diffuser 220 functions to diffuse the incident light, the first diffuser 220 may be formed to have a shape bent in a direction in which the first diffuser 220 may spread the light. For example, the first diffuser 220 may be shaped to protrude in the direction of the light emitted from the LED light source 120. In other words, the first diffuser 220 has a protrusion that extends along a direction in which light emitted from the LED light source 120 propagates. Specifically, light incident upon a central portion of the protrusion of the first diffuser 220 propagates substantially straight with little deviation. By contrast, light incident on a peripheral portion of the protrusion of the first diffuser 220 exhibits an increased angle of incidence and, as such, is refracted at an increased refraction angle. Accordingly, when the first diffuser 220 is manufactured to have a protruding shape, the first diffuser 220 may exhibit an increased diffusion rate at the peripheral portion thereof, as compared to the case in which the first diffuser 220 has a concave shape.

In another example, a portion of the light guide 200 corresponding to the LED light source 120 may be recessed in a direction opposite to the LED light source 120 to form the first diffuser 220. For example, light passing through the recessed shape of the first diffuser 220 may also be diffused in various directions.

The shape of the first diffuser 220 may also be formed to reflect and refract incident light in various directions. For example, when the first diffuser 220 has a shape having multiple angled faces, such as a dome shape, an angle bracket shape, a pyramid shape, a prism shape, a shape having irregular curved surfaces, a shape having fine irregularities, or the like, the first diffuser 220 may diffuse light at an increased diffusion rate.

Additionally, the first diffuser 220 may be formed to have a symmetrical shape in order to uniformly control the diffusion path or the like of light.

In the LED module 100, in addition to diffusion of light, intensity of light is also an important factor. Therefore, the first diffuser 220 may be formed at a position corresponding to the LED light source 120 in order to prevent leakage of light emitted from the LED light source 120 and to maximally accommodate the light emitted from the LED light source 120. Specifically, when the center of the light emitted from the LED light source 120 is aligned with the center of the first diffuser 220, the first diffuser 220 may accommodate most of the light emitted from the LED light source 120. Accordingly, light intensity and light diffusion may be effectively balanced and, as such, projection of optimized light may be achieved.

The second diffuser 240, which again diffuses the light diffused by the first diffuser 220, is formed at the light guide 200. The second diffuser 240 described above may be formed at a boundary surface among the plurality of layers of the light guide 200.

In another example, the second diffuser 240 may be formed through coupling of the first layer 210 and the second layer 230 using injection molding.

In another example, the second diffusion layer 240 may be formed through dual injection molding of the first layer 210 and the second layer 230.

In another example, the second diffuser 240 may be formed by laminating the first layer 210 and the second layer 230, and then bending a portion of the boundary surface between the first and second layers 210 and 230.

As described, the second diffuser 240 may be formed using various methods. In particular, in the case of dual injection molding, the fine gap between the first layer 210 and the second layer 230 is minimized, enabling the light emitted from the LED light source 120 to be diffused more effectively.

Since the second diffuser 240 serves to re-diffuse the light that has been diffused by the first diffuser 220, the second diffuser 240 may be formed to have a greater width than the first diffuser 220. For example, the light diffused by the first diffuser 220 advances while passing through the second layer 230 and, as such, may be widely diffused. To accommodate the widely diffused light as much as possible, the second diffuser 240 is formed with a greater width than the first diffuser 220.

Similar to the first diffuser 220, the second diffuser 240 should diffuse light. Accordingly, the second diffuser 240 should be formed to have a shape capable of effectively diffusing light. For example, the second diffuser 240 may be formed to have a bent shape. Accordingly, light diffused by the first diffuser 220 enters the bent shape of the second diffuser 240, and is then re-diffused through reflection in various directions and refraction at different angles.

In another example, the second diffuser 240 may have a plurality of continuously-disposed bent shapes. For example, angles of reflection and refraction may be more diverse and, as such, a higher diffusion rate may be obtained.

Specifically, the plurality of bent shapes of the second diffuser 240 may be identical and may be formed continuously. Alternatively, the plurality of bent shapes of the second diffuser 240 may be various and may be continuously disposed. Additionally, different bent shapes may be symmetrically disposed to optimize diffusion and light accommodation.

Since the second diffuser 240 also functions to diffuse light, the second diffuser 240 may be formed to protrude in the direction along which the light emitted from the LED light source 120 propagates. As described with reference to the first diffuser 220, such a shape may diffuse the light toward the periphery thereof through reflection and refraction at various angles.

Additionally, to maximally accommodate and re-diffuse the light diffused by the first diffuser 220, the second diffuser 240 may be formed at a position corresponding to the first diffuser 220.

For example, when the second diffuser 240 is formed to have a bent shape, it may be possible to align the center of the second diffuser 240 with the center of the first diffuser 220. When the second diffuser 240 has a plurality of bent portions continuously disposed, it may be possible to align the center of the second diffuser 240 or the center of the continuously disposed bent portions with the center of the first diffuser 220. In other words, the position of the second diffuser 240 is determined to maximally accommodate light emerging from the first diffuser 220.

By utilizing a multi-diffusion structure as in the first diffuser 220 and the second diffuser 240 as described above, luminance and contrast differences become more uniform. As a result, it may be possible to uniformly diffuse the light emitted from the LED light source 120.

The light guide 200 may include scattering particles 270 for dispersion and scattering. The scattering particles 270 have various functions. For example, the scattering particles 270 scatter light entering the light guide 200 in multiple directions to achieve uniform brightness. Additionally, when the light entering the light guide 200 is in a total internal reflection state, the scattering particles 270 disrupt the total internal reflection path of the light in order to enable the light to exit in a designed direction.

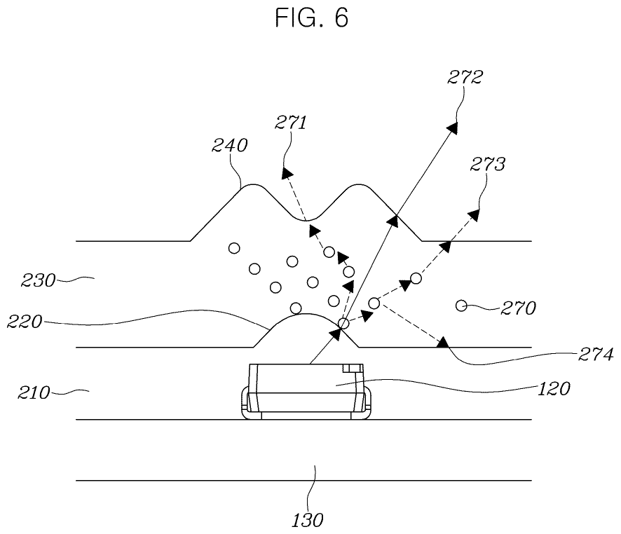

FIG. 6 is a view showing a diffusion path of light in the light guide 200 including the scattering particles 270. Hereinafter, the light guide 200 including the scattering particles 270 and the path of light passing through the light guide 200 are described with reference to FIG. 6.

Light beams 271, 272, 273, and 274 emitted from the LED light source 120 exit the first diffuser 220 at the same point while passing through the first diffuser 220. However, the light beams 271, 272, 273, and 274 exit at various angles in accordance with incidence angles thereof upon the first diffuser 220. Additionally, the light beams 271, 272, 273, and 274 emerging from the first diffuser 220 enter the same scattering particle 270. For example, paths of the light beams 271, 272, 273, and 274 are changed in various directions in accordance with angles of incidence thereof upon the scattering particle 270 and the position of the scattering particle 270. As a result, the path of light entering the second diffuser 240 is divided into paths of light 271 incident toward the center of the second diffuser 240, light 272 incident toward the outside of the second diffuser 240, light 273 incident upon a boundary surface of the second layer 230, and light 274 incident upon a boundary surface between the first layer 210 and the second layer 230.

The scattering particles 270 influence the performance of the light guide 200 including light brightness, uniformity, and viewing angle, etc. Since the performance of the light guide 200 is also varied depending on the wavelength of the light, the size of the scattering particles 270 should be determined taking into consideration the wavelength of light and the performance of the light guide 200. Additionally, when the scattering particles 270 are too small in size, scattering becomes weak, and when the scattering particles 270 are too large in size, optical loss becomes great due to absorption and other factors. Therefore, it may be important to select an appropriate size of the scattering particles 270.

For example, when the size of the scattering particles 270 exceeds 1 micrometer, issues such as light absorption, total internal reflection, chromatic aberration, etc. may occur. As the particle size increases, transparency decreases, ultimately reducing the transmittance of the light guide 200.

When the scattering particles 270 are formed to have a size similar to the wavelength of the light, Mie scattering occurs, which increases the amount of light diffused in the advance direction of the light. Therefore, taking into consideration the wavelength of the light emitted from the LED light source 120 and the performance of the light guide 200, the particle size may be determined not to be more than 1 micrometer. However, the size of the scattering particles 270 is not limited to this value; larger sizes may also be used. As described above, the size of the scattering particles 270 may be varied depending on factors such as the wavelength of the incident light, the material of the light guide 200, the overall required performance, etc.

The material of the scattering particles 270 should also be selected to match the material of the light guide 200. For example, materials such as BaSO₄, TiO₂, ZnO, Al₂O₃, CaCO₃, PMMA, and the like may be used. In particular, when scattering particles 270 made of BaSO₄ are mixed into the layers 210 and 230 made of PC or PMMA, maximal effects may be obtained. The BaSO₄ particles described above may be manufactured through methods such as precipitation, hydrothermal synthesis, etc.

Meanwhile, to maximize both high light transmission efficiency and scattering ability, anatase-type TiO₂ with a high optical bandgap may be selected.

The second diffuser 240 and the first diffuser 220 serve to change the advance direction of light in order to diffuse the light. Therefore, a sufficient space allowing light passing through the first diffuser 220 and the second diffuser 240 in a state of being changed in advance direction to travel continuously is necessary. However, for effective re-diffusion of light in the second diffuser 240, most of the light emerging from the first diffuser 220 should be accommodated in the second diffuser 240. To facilitate this, the distance between the second diffuser 240 and the surface of the light guide 200 opposite to the second diffuser 240 may be longer than the distance between the first and second diffusers 220 and 240. For example, the light passing through the second diffuser 240 may travel a sufficient distance and, as such, may finally reach the opposite surface of the light guide 200 in a sufficiently diffused state, as compared to an initial state in which the light is emitted from the LED light source 120.

As described above, the light emitted from the LED light source 120 spreads widely as the light passes through the first diffuser 220 and the second diffuser 240. This phenomenon enhances the uniformity of the light when the LED light source 120 is used alone. Additionally, when each of the LED light source 120, the first diffuser 220, and the second diffuser 240 is disposed in plural, new effects may be expected.

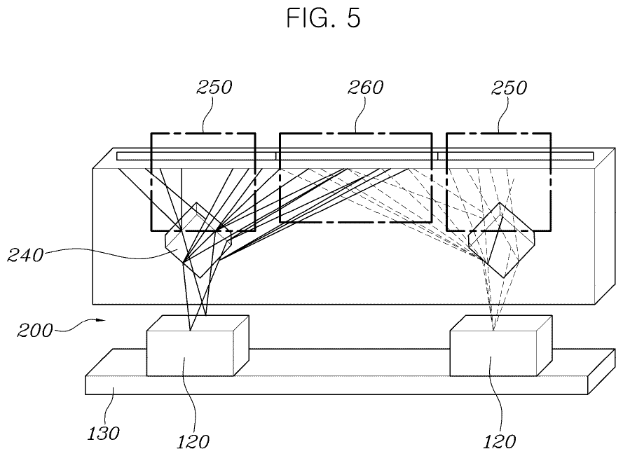

FIG. 5 shows that light beams respectively emitted from a plurality of LED light source sets 110 form an overlap region 260 as the light beams pass through respective light guides 200. Hereinafter, new effects obtained through disposition of the plurality of LED source sets 110 will be described with reference to FIG. 5.

Each LED light source set 110 is constituted by the LED light source 120, the light guide 200, the first diffuser 220, and the second diffuser 240. When the LED light source sets 110 as described above are disposed to be spaced apart from one another, light traveling straight from the second diffuser 240 and light diffused at a small angle from the second diffuser 240, which are included in re-diffused light in one second diffuser 240, do not overlap with light diffused from another second diffuser 240 and, as such, form a non-overlapping region (hereinafter referred to as “an independent region” 250). On the other hand, light heavily diffused from one second diffuser 240, which is included in light re-diffused in the one second diffuser 240, overlaps with light diffused from another second diffuser 240 and, as such, forms the overlap region 260.

As the overlap region 260 is formed as described, a uniform overall light intensity may be obtained. Specifically, in areas far from individual LED light sources 120, the light intensity may be weaker. However, light beams respectively emitted from the LED sources 120 may overlap in the areas weak in light intensity. As a result, the overall light intensity becomes uniform.

Additionally, when LED light sources 120 respectively configured to emit light of different colors are used in respective LED light source sets 110, light beams emitted from the LED light sources 120 are mixed in the overlap regions, resulting in overall formation of natural mixed colors.

In order to maximize effects of increased light uniformity and mixed color formation, the overlapping region 260 and the independent region 250 may be formed alternately through disposition of a plurality of LED light source sets 110 such that the LED light source sets 110 are spaced apart from one another. Accordingly, it may be possible to produce uniform light and to form natural mixed colors, using relatively fewer LED sources 120.

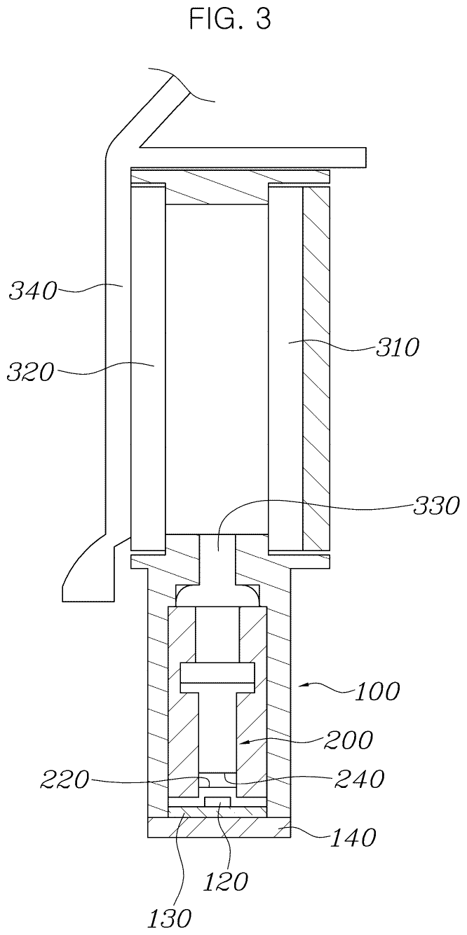

In accordance with an embodiment, the lamp 300 may use the above-described LED module 100 as a light source thereof configured to emit light. Referring to FIG. 3, in the lamp 300, the LED module 100 and the inner lens 330 configured to allow light emitted from the LED module 100 to pass therethrough are disposed. Additionally, the high-reflectivity part 310 configured to reflect 90% or more of light incident thereupon is formed at one side of the LED module 100, and the low-reflectivity part 320 configured to reflect a part of light incident thereupon and to transmit the remaining part of the incident light therethrough is formed at the other side of the LED module 100 opposite to the high-reflectivity part 310.

Since the high-reflectivity part 310 should have a high reflectance, the high-reflectivity part 310 may be formed using materials such as aluminum, silver, gold, etc. These materials may be manufactured through methods such as polishing, deposition, coating, etc. In particular, when aluminum is used, there are advantages of high reflectivity, excellent thermal conductivity, heat resistance, and ease of shaping and processing.

The low-reflectivity part 320 may be formed using a metal thin film or a dielectric thin film or the like. The metal thin film may made of silver, aluminum, chromium, nickel, gold, or the like. The low-reflectivity part 320 may be manufactured using a method such as deposition, coating, or the like. In particular, when the low-reflectivity part 320 is manufactured through deposition of a silver film and a protective layer of SiO₂, there are advantages of an optimal balance between reflectance and transmittance and an extended lifespan.

The low-reflectivity part 320 may be formed such that transmittance and reflectance thereof are each within a range of 30 to 70%. Specifically, the user 400 may recognize illumination only when light passes through the low-reflectivity part 320. Accordingly, when the low-reflectivity part 320 is formed to have transmittance of 60% or more, the user may recognize illumination.

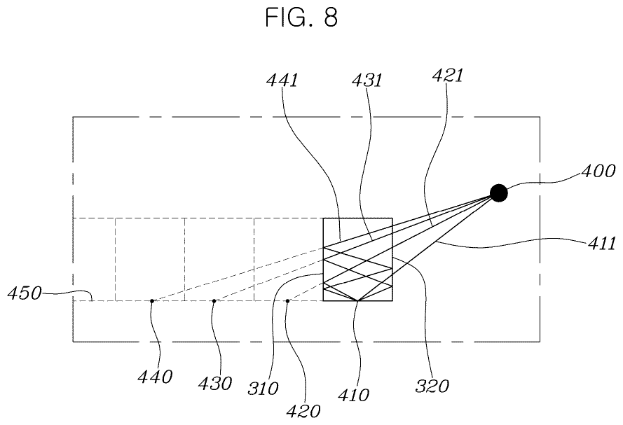

FIGS. 3, 7, and 8 are views showing an actual image 410 and virtual images 420, 430, and 440 perceived by the user 400 based on light paths in the lamp 300. Referring to FIGS. 3 and 8, light emitted from the LED module 100 passes through the inner lens 330 and enters the high-reflectivity part 310 or the low-reflectivity part 320. For example, light 411, which initially enters the low-reflectivity part 320 and then passes through the low-reflectivity part 320, is directed toward the user 400 and, as such, is perceived by the user 400 as the actual image 410.

On the other hand, light beams 421, 431, and 441, which are included in the light emitted from the LED module 100, but do not directly enter the low-reflectivity part 320, pass through the low-reflectivity part 320 after being reflected by the high-reflectivity part 310 and are directed toward the user 400. The light beams 421, 431, and 441 are perceived by the user 400 as virtual images 420, 430, and 440 formed on a virtual plane 450 passing through the actual image 410 in a state of being spaced apart from the actual image 410.

For example, the light 421, which is included in the light emitted from the LED module 100, is reflected once by the high-reflectivity part 310, enters the low-reflectivity part 320, passes through the low-reflectivity part 320, and is then directed toward the user 400. Accordingly, the light 421 is perceived by the user 400 as the virtual image 420.

In another example, the light 431, which is included in the light emitted from the LED module 100, is reflected by the low-reflectivity part 320, is then reflected by the high-reflectivity part 310, subsequently passes through the low-reflectivity part 320, and is then directed toward the user 400. Accordingly, the light 431 is perceived by the user 400 as the virtual image 430.

In another example, the light 441, which is included in the light emitted from the LED module 100, is reflected by the high-reflectivity part 310, is then reflected by the low-reflectivity part 320, is reflected again by the high-reflectivity part 310, and finally passes through the low-reflectivity part 320 to be directed toward the user 400. Accordingly, the light 441 is perceived by the user 400 as the virtual image 440.

For such a multi-reflection structure, the high-reflectivity part 310 and the low-reflectivity part 320 may be disposed in a state of being adjusted in position and angle so that reflected light beams are directed toward each other. Additionally, the number of virtual images 420, 430, and 440 perceived by the user 400 may be varied depending on heights of the high-reflectivity parts 310 and the low-reflectivity part 320, the distance between the high-reflectivity parts 310 and the low-reflectivity part 320, or the transmittance of the low-reflectivity part 320.

Specifically, increasing the heights of the high-reflectivity part 310 and the low-reflectivity part 320 may result in a greater number of reflected light paths. As a result, the number of virtual images perceived by the user 400 increases.

Similar to the above-described principle, increasing the distance between the high-reflectivity part 310 and the low-reflectivity part 320 reduces the number of reflected light paths. As a result, the number of virtual images perceived by the user 400 may decrease.

Assuming that the reflectance of the high-reflectivity part 310 is ‘A” and the transmittance of the low-reflectivity part 320 is “B”, brightness “C” of a specific light source may be expressed by the following two expressions.

C_{{2n-1}}=(1−B)^{{n-1}}·A{ⁿ⁻¹}·B

C_{{2n}}=(1−B)^{{n-1}}·A{ⁿ}·B

Where, “n” is a natural number, “C₀” represents light directly transmitted without reflection, “C₁” represents light reflected once, and “C₂” represents light reflected twice.

Accordingly, increasing the transmittance B of the low-reflectivity part 320 results in a smaller decrease in brightness, allowing an increased number of images to be perceived by the user 400. Conversely, decreasing the transmittance B of the low-reflectivity part 320 results in a greater decrease in brightness, allowing a decreased number of images to be perceived by the user 400. However, since the brightness C of the light source may have some degree of variability, it may be possible to infer the brightness of lighting through the above-described expressions.

As discussed above, the lamp 300 may enable the user 400 to perceive a desired number of images by adjusting at least one of the heights of the high-reflectivity part 310 and the low-reflectivity part 320, the distance between the high-reflectivity part 310 and the low-reflectivity part 320, or the transmittance B of the low-reflectivity part 320 in accordance with the brightness of the light emitted from the LED module 100 and a required number of images.

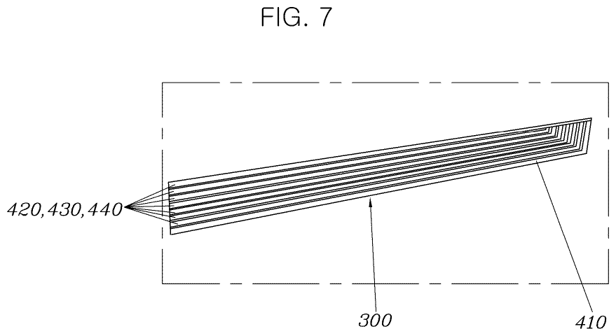

Finally, as the actual image 410 and the virtual images 420, 430, and 440 are simultaneously perceived by the user 400, the user 400 may view the actual image 410 and the virtual images 420, 430, and 440 at the same time, as shown in FIG. 7. The lamp 300 as described above may provide a greater sense of space even in an environment with a limited space in a vehicle, and may also allow the user 400 to view, in the form of several images, mixed colors resulting from intersection of the overlap region 260 and the independent region 250 of the LED module 100. When the multi-reflection structure and the mixed colors as described above are utilized, it may be possible to enhance aesthetics perceived by the user 400. Additionally, it may be possible to transfer various information to the user 400 through light flickering or colors, thereby improving functions of the vehicle.

For example, in a state in which the lamp is installed at an inside of a vehicle door, it may be possible to warn the user 400 of an external obstacle, a pedestrian, etc. when the user 400 exits the vehicle, using light flickering or warning colors. Additionally, information about the vehicle's driving status or an interior environment may be displayed in various colors.

As apparent from the above description, in accordance with the LED module of the present disclosure and the lamp including the LED module, the light uniformity of the LED module may be enhanced and, as such, an enhancement in aesthetics may be achieved. Additionally, performance in terms of visibility, fatigue reduction, and convenience for users may be enhanced.

Additionally, by utilizing the lamp configured to utilize light reflection, it may be possible to provide users with a greater sense of space in spite of spatial constraints of the lamp installed within the vehicle interior. The lamp may also be configured to be added with not only aesthetic features, but also functional features such as information transfer through light color or other factors.

Effects attainable in the present disclosure are not limited to the above-described effects, and other effects of the present disclosure not yet described will be more clearly understood by those having ordinary skill in the art from the above description.

Although the embodiments of the present disclosure have been disclosed for illustrative purposes, those having ordinary skill in the art should appreciate that various modifications, additions and substitutions are possible, without departing from the scope and spirit of the disclosure as disclosed in the accompanying claims.

What is claimed is:

1. An LED module comprising:
an LED light source;
a light guide disposed adjacent to the LED light source and comprising a plurality of laminated layers;
a first diffuser formed at a first side surface of the light guide facing the LED light source and configured to diffuse light incident from the LED light source; and
a second diffuser formed at a boundary surface among the plurality of layers of the light guide and configured to re-diffuse light that has been diffused through the first diffuser.

2. The LED module of claim 1, wherein the first diffuser has a bent shape such that the light incident on the first diffuser from the LED light source is refracted and diffused.

3. The LED module of claim 1, wherein the first diffuser has a protruding shape extending in a direction along which light emitted from the LED light source propagates.

4. The LED module of claim 1, wherein a portion of an outer surface of the light guide, corresponding to the LED light source, is recessed in a direction opposite to the LED light source, thereby forming the first diffuser.

5. The LED module of claim 1, wherein the first diffuser is formed at a position corresponding to the LED light source such that the first diffuser accommodates light emitted from the LED light source.

6. The LED module of claim 1, wherein the second diffuser has a width greater than a width of the first diffuser.

7. The LED module of claim 1, wherein the second diffuser has a bent shape configured to refract and diffuse light incident upon the second diffuser as the incident light passes through the second diffuser.

8. The LED module of claim 1, wherein the second diffuser comprises a plurality of bent portions disposed continuously.

9. The LED module of claim 1, wherein the second diffuser has a protruding shape extending in a direction along which light emitted from the LED light source propagates.

10. The LED module of claim 1, wherein a distance between the second diffuser and a second side surface of the light guide is greater than a distance between the first diffuser and the second diffuser.

11. The LED module of claim 1, wherein the second diffuser is formed at a position corresponding to the first diffuser to accommodate light diffused by the first diffuser.

12. The LED module of claim 1, wherein a portion of the boundary surface among the plurality of layers of the light guide is bent, thereby forming the second diffuser.

13. The LED module of claim 1, wherein:
the LED module comprises a plurality of LED light source sets spaced apart from one another;
each of the plurality of LED light source sets includes the LED light source, the light guide, the first diffuser, and the second diffuser; and
an overlap region is defined between adjacent LED light source sets, the overlap region being configured such that light beams emitted by the adjacent LED light source sets overlap.

14. The LED module of claim 13, wherein, an independent region is defined in which light beams by each LED light source set do not overlap with the light beams emitted from the adjacent LED light source sets, and the overlap regions and the independent regions are alternately formed.

15. The LED module of claim 1, wherein at least one of the plurality of laminated layers includes scattering particles dispersed therein, the scattering particles having a size corresponding to a wavelength of light emitted from the LED light source.

16. A lamp comprising:
an LED module comprising an LED light source, a light guide including a plurality of laminated layers, a first diffuser formed at a side surface of the light guide facing the LED light source, and a second diffuser formed at a boundary surface among the layers of the light guide;
a high-reflectivity part disposed at a first side of the LED module and configured to reflect incident light emitted from the LED module; and
a low-reflectivity part disposed at a second side of the LED module and configured to reflect a part of incident light emitted from the LED module and to transmit a remaining part of the incident light.

17. The lamp of claim 16, wherein, among the light emitted from the LED module, light directed toward a user after directly passing through the low-reflectivity part forms an actual image of the LED light source.

18. The lamp of claim 16, wherein, among the light emitted from the LED module, light directed toward a user after being reflected by the high-reflectivity part and then passing through the low-reflectivity part forms a virtual image on a virtual plane passing through the LED light source in a state of being spaced apart from the LED light source.

19. The lamp of claim 18, wherein reflections from at least one of the high-reflectivity part or the low-reflectivity part along different paths form multiple virtual images, and a number of the multiple virtual images varies based on at least one of a height of the high-reflectivity part, a height of the low-reflectivity part, or a distance between the high-reflectivity part and the low-reflectivity part.

20. The lamp of claim 16, wherein the low-reflectivity part is formed such that transmittance thereof for incident light is higher than reflectance thereof for the incident light.
